(19) United States
(12) Patent Application Publication
(10) Pub. No.: US 2015/0178346 A1
(43) Pub. Date: Jun. 25, 2015

(54) USING BIOMETRIC DATA TO IDENTIFY DATA CONSOLIDATION ISSUES

(71) Applicant: INTERNATIONAL BUSINESS MACHINES CORPORATION, Armonk, NY (US)

(72) Inventors: Paul D. Bailey, Tuscon, AZ (US); William J. Oliver, Tuscon, AZ (US)

(73) Assignee: INTERNATIONAL BUSINESS MACHINES CORPORATION, Armonk, NY (US)

(21) Appl. No.: 14/138,011

(22) Filed: Dec. 21, 2013

(51) Int. Cl. G06F 17/30

(52) U.S. Cl. CPC G06F 17/30371

(57) ABSTRACT

A method, system or computer usable program product for identifying false nexuses in previously consolidated data including receiving a set of biometric information corresponding to a consolidated record of a consolidation database; utilizing a processor to test the set of biometric data for similarity; and responsive to detecting a similarity less than a threshold indicating a false nexus, performing a separation action related to the consolidated record.

### BACKGROUND

1. Technical Field

The present invention relates generally to using biometric data to identify data consolidation issues, and in particular, to a computer implemented method for using biometric data to identify possible false nexuses within consolidated data.

2. Description of Related Art

In a wide variety of applications, data can be collected from or about individuals. This data can include activities, preferences, socio-economical and other attributes, etc. of an individual. This data can be collected from a variety of sources. This data becomes more useful and valuable as it is consolidated to provide a more complete description of an individual.

There are a variety of entities that gather this type of data, whether directly from individuals or form third party suppliers, and then combine or otherwise consolidate that data. They may then use that consolidated information for their own internal business or governmental purposes or they may provide the consolidated data to other entities or persons for monetary or other considerations.

### SUMMARY

The illustrative embodiments provide a method, system, and computer usable program product for identifying false nexuses in previously consolidated data including receiving a set of biometric information corresponding to a consolidated record of a consolidation database; utilizing a processor to test the set of biometric data for similarity; and responsive to detecting a similarity less than a threshold indicating a false nexus, performing a separation action related to the consolidated record.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a system for consolidating multiple databases in which a first embodiment may be implemented;

FIG. 4 is a is a block diagram of a system for deconsolidating a previously consolidated database in which a second embodiment may be implemented;

FIG. 5 is a is a flow diagram of a database consolidator consolidating multiple databases in accordance with a first embodiment;

FIG. 6 is a flow diagram of a database deconsolidator reviewing a consolidated database for false nexuses in accordance with the second embodiment;

FIG. 7 is a block diagram of a system for deconsolidating a previously consolidated database in which a third embodiment may be implemented; and

FIG. 8 is a flow diagram of a database deconsolidator reviewing a consolidated database for false nexuses in accordance with the third embodiment.

### DETAILED DESCRIPTION

Processes and devices may be implemented and utilized for using biometric data to identify data consolidation issues. These processes and apparatuses may be implemented and utilized as will be explained with reference to the various embodiments below.

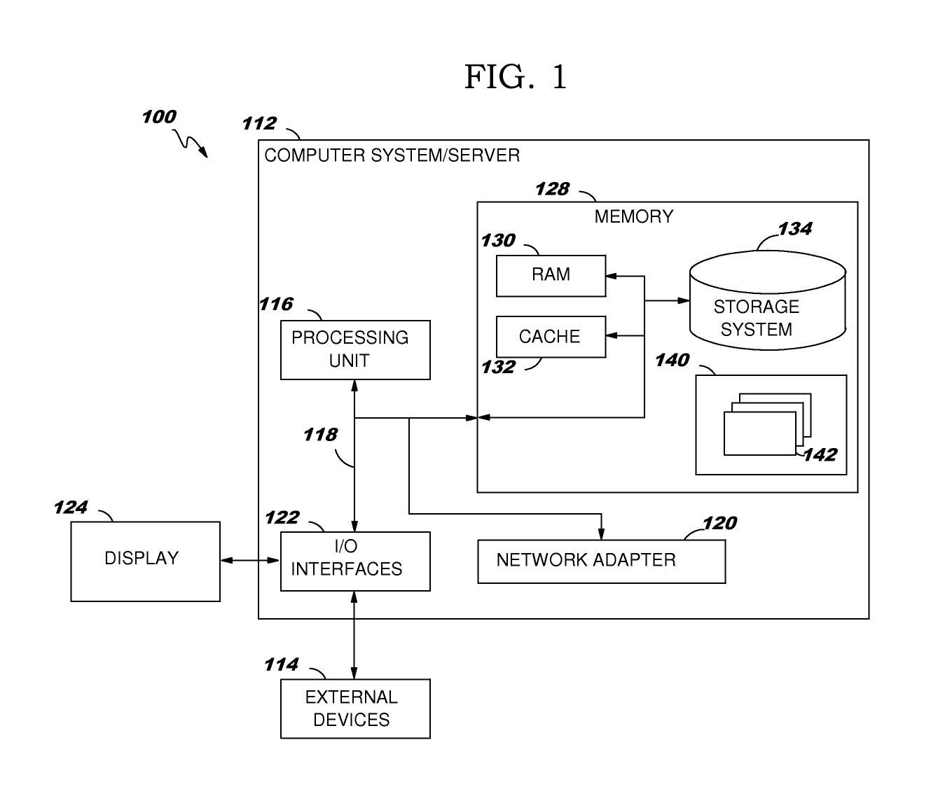

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as using biometric data to identify data consolidation issues.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system usable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for using biometric data to identify data consolidation issues.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

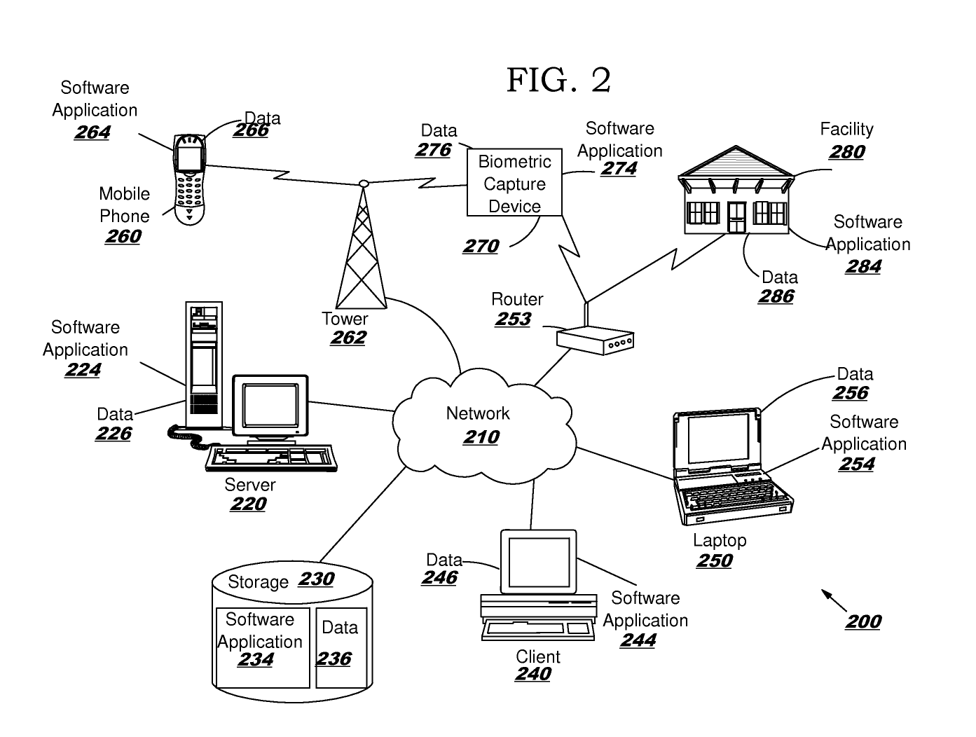

FIG. 2 is a block diagram of an illustrative network of data processing systems in which various embodiments of the present disclosure may be implemented. Data processing environment 200 is a network of data processing systems such as described above with reference to FIG. 1. Software applications such as for using biometric data to identify data consolidation issues may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220, client 240 and laptop 250 are coupled to network 210 along with storage unit 230. In addition, biometric capture device 270 and facility 280 (such as a home or business) are coupled to network 210 including wirelessly such as through a network router 253. A mobile phone 260 and biometric capture device 270 may be coupled to network 210 through a mobile phone tower 262. Data processing systems, such as server 220, client 240, laptop 250, mobile phone 260, biometric capture device 270, and facility 280 contain data and have software applications including software tools executing thereon. Other types of data processing systems such as personal digital assistants (PDAs), smartphones, tablets and netbooks may be coupled to network 210. Biometric capture device 270 can be any device which can capture biometric information of a person with other identifying information including an ATM machine camera coupled with facial recognition software, a fingerprint pad on a laptop, a smartphone camera coupled with facial recognition software, a smartphone microphone coupled with voice recognition software, etc.

Server 220 may include software application 224 and data 226 for using biometric data to identify data consolidation issues or other software applications and data in accordance with embodiments described herein. Storage 230 may contain software application 234 and a content source such as data 236 for using biometric data to identify data consolidation issues. Other software and content may be stored on storage 230 for sharing among various computer or other data processing devices. Client 240 may include software application 244 and data 246. Laptop 250 and mobile phone 260 may also include software applications 254 and 264 and data 256 and 266. Biometric capture device 270 and facility 280 may include software applications 274 and 284 and data 276 and 286. Other types of data processing systems coupled to network 210 may also include software applications. Software applications could include a web browser, email, or other software application for using biometric data to identify data consolidation issues.

Server 220, storage unit 230, client 240, laptop 250, mobile phone 260, biometric capture device 270 and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260, biometric capture device 270 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

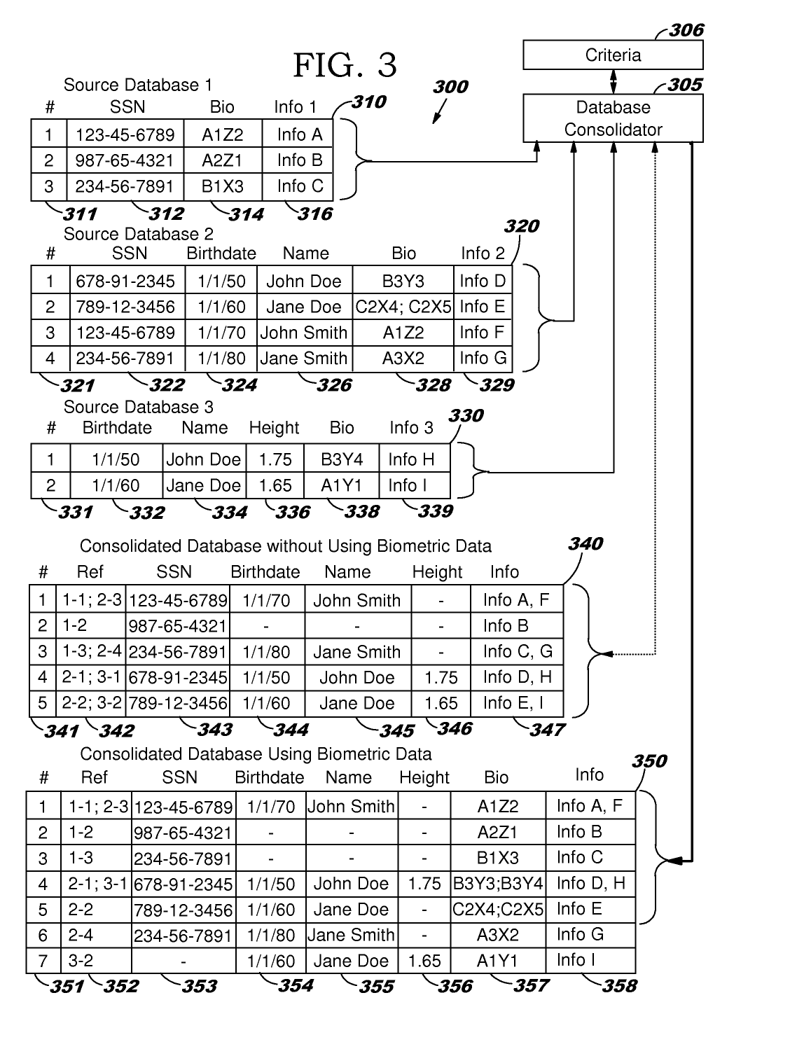

FIG. 3 is a block diagram of a system 300 for consolidating multiple databases in which various embodiments may be implemented. Three databases 310, 320 and 330 are shown ready to be consolidated using database consolidator 305 based on criteria 306. Each database contains different information about several people, some of which may be in common. By consolidating these disparate databases, a fuller understanding of each person can be constructed. These disparate databases may be derived from a variety of sources including driver licenses, registration in a variety of websites, survey data collected, record management systems (RMS), jail management systems (JMS), other data management systems, etc. These disparate databases may also be derived from a common source, but contain different types of information of the same people, such as by collecting the information at different times, by using different tools etc. The results of the consolidation can be utilized for a variety of purposes including on-line marketing, criminal background searches, financial investigations, etc. Database consolidator 305 may be implemented in software on a data processing system, in hardware as a specialized set of circuits, a combination of these approaches, or in other alternative implementations. The criteria are a set of rules for determining whether two records are describing the same individual. For example, if two records have the same social security number, then both records probably describe the same individual unless other data indicates otherwise such as birthdate and biometric data. The criteria can include a threshold amount or confidence amount acceptable for determining that two sets of biometric information are describing the same person. This threshold amount can vary depending on the type of biometric information used and the reliability of that biometric information. For example, fingerprint data may be considered more reliable than facial or voice recognition biometrics. Source databases 310, 320 and 330, consolidated databases 340 and 350, and criteria 305 may be located in local memory or in remote servers or other data processing systems.

Database 310 includes a set of three records with record number 311, social security numbers (SSN) 312, biometric information 314, and other descriptive information 316 about three different persons. Other descriptive information 316 can include a variety of information such as buying habits, general web surfing activities, general banking information, and other personal characteristics. Record numbers can be utilized as described below for referencing individual records. They are shown sequentially here, but other types of numbering schemes may be utilized. Database 320 includes a set of four records with record number 321, social security numbers (SSN) 322, birthdate 324, name 326, biometric information 328 and other descriptive information 329 (similar to but different from other descriptive information 316) about four different people. Record 2 of database 320 includes two different sets of biometric data which can be derived from two different sources such as photographs taken at different times and location. Database 330 includes a set of two records with record number 331, birthdate 332, name 334, height 336, biometric information 338 and other descriptive information 339 (similar to but different from other descriptive information 316 and 329) about two different people. By consolidating these databases, a fuller understanding of each person can be constructed. Consolidating is not just combining databases by putting all their records in a common database, but includes identifying where records in each database may be describing the same person and then combining those records into a single record by using a rules engine or other heuristics. A record is a set of information within a domain or database that establishes a relationship between a set of data or data elements. A record may be a separate entry into a database, a set of links between data, or other logical relationship between a set of data.

Biometric data or information can include facial recognition, fingerprints, voice recognition, DNA, etc. Biometric information includes biological metrics for an individual that are consistent over time that can be utilized for distinguishing that individual from other individuals. There are many types of biometric information gathered today with a variety of formats, many of which are proprietary. No specific type of biometric data is shown here and the examples given are for illustrative purposes only. Many types of biometric information could be utilized in this and other implementations. In this example, a common analytical tool was utilized to generate the biometric information. However, raw source biometric data such as photographs may be stored instead which can then be analyzed at a later time such as during consolidation or during post-consolidation analysis.

There are two results of the consolidation shown. The first consolidated database 340 is generated without utilizing any of the biometric data collected for each person in each database, as indicated with the dotted line. This is similar to what occurs if no biometric information is available when then databases are consolidated. As a result, due to different individuals having the same name and birthdate or due to two individuals having the same social security number, records from different individuals could be accidentally and incorrectly consolidated, which is referred to as a false nexus. Lest one think that two people may not share the same social security number at any time, data entry errors can occur and it is not uncommon for a person to accidentally write or mistype the wrong social security number down in a variety of circumstances, whether accidentally or not. The second consolidated database 350 is generated utilizing the biometric data collected for each person in each database, as indicated with the solid line. This allows for greater accuracy in determining whether two records represent the same person.

The first consolidated database 340 includes a record number 341, reference identifier 342 of the source database(s) and record(s), social security number 343, birthdate 344, name 345, height 346 and other descriptive information 347. Since no biometric information was utilized, it is also not collected in the resulting database 340. As shown, the 9 records of the three source databases 310, 320 and 330 were consolidated into 5 records in database 340. While this provides for a great deal of consolidation, mistakes can occur due to over aggressive rules on consolidation or lack of sufficient distinguishing information, resulting in a false nexus and a false understanding of some of the underlying individuals.

The second consolidated database 350 includes a record number 351, reference identifier 352 of the source database(s) and record(s), social security number 353, birthdate 354, name 355, height 356, biometric information 357 and other descriptive information 358. In this example, the 9 records of the three source databases 310, 320 and 330 were consolidated into 7 records in database 350. The first record of database 310 and the third record of database 320 have the same social security number and the same biometric information, so they were combined thereby generating the first record of database 350. However, although the third record of database 310 and the fourth record of database 320 have the same social security number, they do not have the same or similar biometric information, so they are not consolidated. In this case, the dissimilarity may be flagged for special review, whether by machine or a human. Such a review could identify whether an incorrect social security number of an incorrect collection of biometric information was collected. In addition, the second record of database 320 was not consolidated with the second record of database 330 because although they shared the same name and birthdate, they did not share the same biometric information.

One consolidation was performed in this example without a perfect match of biometric information. The first record of database 320 was combined with the first record of database 330. They shared the same name and birthdate, but their biometric information differed. In this example, one record had biometric information B3Y3 and the other had biometric information B3Y4. Although they were different, the difference could be considered minor. A similarity score can be generated and threshold test can be performed on the difference to determine whether it fell within normal statistical variation. If so, the records could be combined. That record could also be flagged for special review, whether by machine or by a human. Although the example shown only includes individual consolidated records that are from two source databases, a consolidated record could include records consolidated from three or more source databases utilizing the same principles described herein.

Database 340 could be checked using biometric information after it has been created, as indicated by the dotted line back to database consolidator 305. For example, if no biometric information was available when database 340 was created, then that result is expected. However, once biometric information is collected and referenced to the corresponding record and database, then database 340 could be reviewed for identifying and flagging those records with a false nexus. This can be accomplished by referencing the underlying source databases that now contain biometric information to identify records of by referencing biometric information in a separate database that references the corresponding database and record to which each item of biometric information applies. This records that may be suspect may be flagged for special review. In addition, corrections could be made by deconsolidating suspect records while referencing the underlying source databases.

Although complete databases 340 and 350 are shown including all underlying data from source databases 310, 320 and 330, alternative embodiments may utilize alternative methods of storing the information. For example, databases 340 and 350 could simply contain pointers to the data stored in source databases 310, 320 and 330. In addition, the biometric information stored and used for comparison may be an analysis of source biometric information as shown, or it may be the raw source data itself which can then be analyzed during the comparison process. For example, raw photos of individuals can be stored in the source databases with the corresponding data or those raw photos may be stored in a separate database with references or other linkages to the corresponding source database records. The raw photos can then be analyzed using a common analytical tool as the databases are consolidated or reviewed post-consolidation.

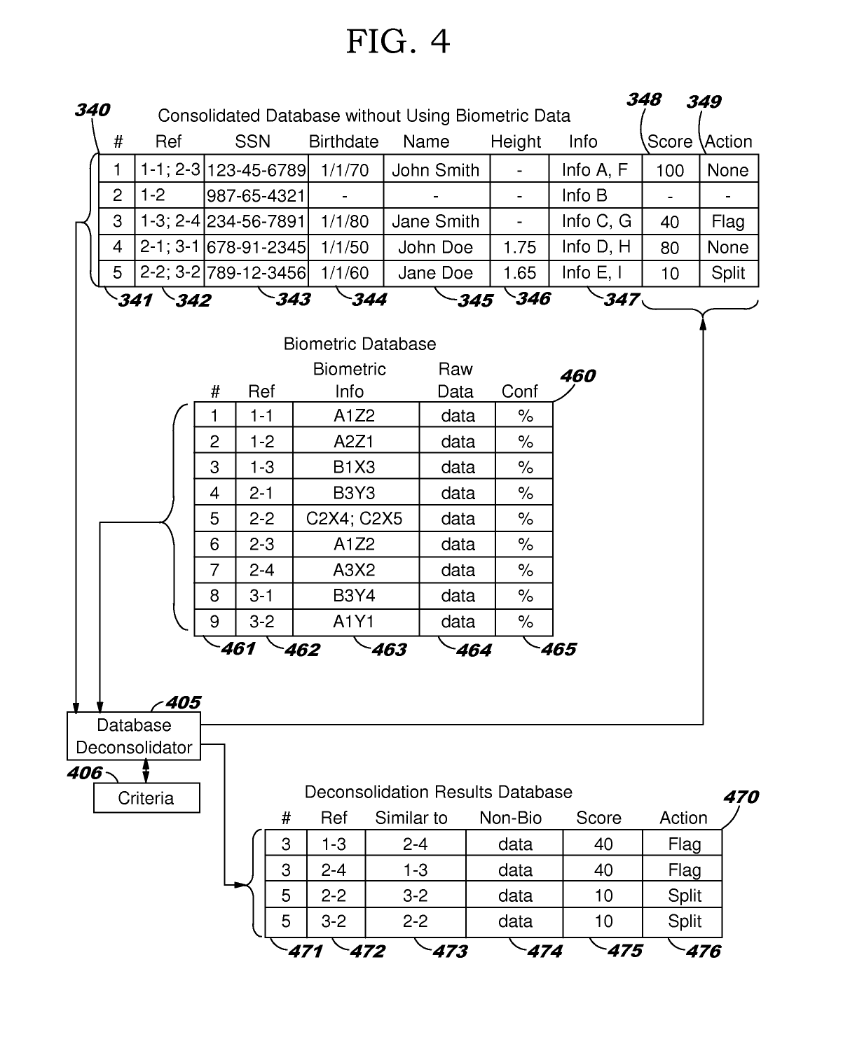

FIG. 4 is a block diagram of a system for deconsolidating a previously consolidated database in which various embodiments may be implemented. Consolidated database 340 from FIG. 3 is shown as an example of a database consolidated without using consolidated data that can be deconsolidated by utilizing database deconsolidator 405 with a biometric database 460 and a set of criteria 406. The consolidated database includes record number 341, reference identifier 342 of the source databases and records, social security number 343, birthdate 344, name 345, height 346 and other descriptive information 347. Also shown are a score 348 and separation action code 349 which are added to database 340 as described below. Alternatively, a deconsolidation results database 470 can be generated capturing the same information at score 348 and separation action code 349 as described below. The criteria are a set of rules for determining whether two records are describing the same individual. For example, if two records have the same social security number, then both records probably describe the same individual unless other data indicates otherwise such as birthdate and biometric data. The criteria can include a threshold amount or confidence amount acceptable for determining that two sets of biometric information are describing the same person. This threshold amount can vary depending on the type of biometric information used and the reliability and credibility of that biometric information. For example, fingerprint data may be considered more reliable than facial or voice recognition biometrics. For another example, social security numbers may be considered more credible than birthdates due to its source and how it may be provided. That is, social security cards are often checked by employers whereas birth certificates are rarely checked. Criteria 406, consolidated database 340, biometric database 460 and deconsolidation results database 470 may be located in local memory or in remote servers or other data processing systems.

Also shown is a biometric database 460 which can be utilized to identify any false nexus within consolidated database 340 based on criteria 406. Biometric database includes a record number 461, a reference identifier 462 of linkage to the source database and record, biometric information 463, raw data 464 and confidence score 465. Reference identifier 462 is utilized to link biometric information with a given record in a source database. For example, record number 2 of the biometric database has biometric information and raw data corresponding to the second record of the first source database. This approach may be utilized when the biometric information was gathered after the consolidation database was generated to allow for deconsolidation where indicated. Biometric information 463 is the same biometric information that was stored in the source databases of FIG. 3. Raw data is the underlying data or pointers to that underlying data used to generate the biometric information such as a photograph of an individual, fingerprint scan, etc. For example, a person may set up a bank account resulting in a record being created with information about that person including their name, social security number, bank balance, etc. Once that person later uses an automatic teller machine (ATM), then a photograph may be taken of that individual and correlated with the prior created record using linkages such as shown in database 460. Confidence score 465 is also included for each entry of biometric information. For example, some photographs are grainier with less resolution or fuzzy due to focus issues, so the resulting biometric information derived from the raw data may be less reliable and the confidence score is lower as a result. This confidence score can be utilized to help reduce the number of false negatives or false positives.

Database deconsolidator 405 uses the biometric information to determine whether there may have been any false consolidation of data between different individuals based on criteria 406. It accomplishes this by looking at each record in the consolidated database, looking up the biometric data corresponding to the reference source records, generating a similarity score, and comparing that to a threshold to determine what separation action to take such as flagging the record to be further processed or split as a false nexus. A separation action includes the marking, separating and flagging actions as well as any other which would tend to selectively separate the consolidated data based on the detection of a false nexus. This process is described in greater detail below. Database deconsolidator 405 may be implemented in software on a data processing system, in hardware as a specialized set of circuits, a combination of these approaches, or in other alternative implementations. Once a record is flagged as a false nexus, the record can be automatically deconsolidated or go through a secondary process possibly including human intervention to determine whether to deconsolidate the record. As illustrated in the example, two records (numbers 3 and 5) are flagged as having a low similarity score, thereby indicating a possible false nexus and a need to be split. Once deconsolidated, the resulting database would appear as shown in database 350 of FIG. 3.

Deconsolidation results database 470 is an alternative approach to identifying records which need a separation action performed such as being split or further processed. Results database includes a record number 471 of consolidated database 340, a reference number 472 to a record in the source database which may have caused the dissimilarity, a second reference number 473 to the record in the source database which also may have caused the dissimilarity, the non-biological metric information 474 which previously appeared to be from the same individual, a similarity score 475 indicating the level of confidence in similarity (which is a low score for considering deconsolidation) and a separation action code 476. There are two records in the results database for each consolidated database record which may have a false nexus, one for each source database record that was the source database. Alternative embodiments may utilize a single record in deconsolidation results database 470 for each apparent false nexus. Alternative embodiments may also add additional records for every comparison, whether a separation action is needed or not, to provide a complete audit trail of deconsolidation results. By using deconsolidation results database 470, the consolidated database can be preserved in its original form until the results database can be processed at a later time. Deconsolidation results database 470 also creates an audit trail useful for a variety of purposes including statistical analysis.

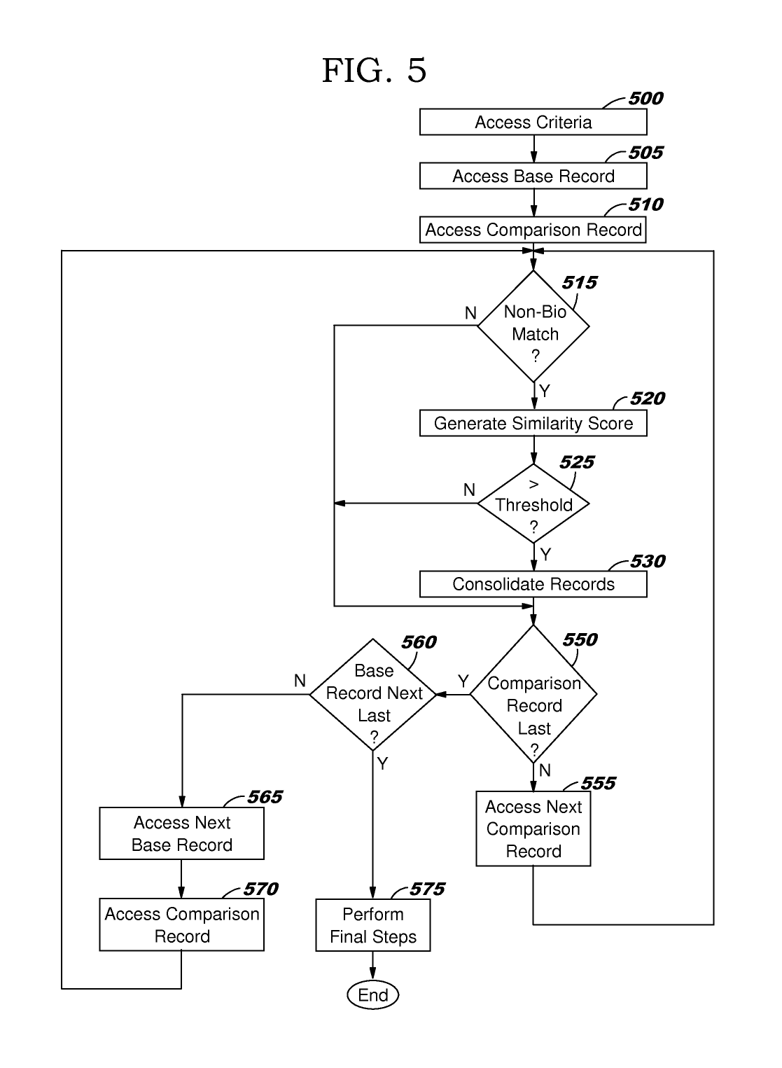

FIG. 5 is a flow diagram of a database consolidator consolidating multiple databases in accordance with a first embodiment. A database consolidator may be implemented in software on a data processing system, in hardware as a specialized set of circuits, a combination of these approaches, or in other alternative implementations. For illustrative purposes, the databases being consolidated are the three source databases of FIG. 3. For illustrative purposes, the records of the three databases will be viewed as in sequential order starting with the first record of the first database and ending with the last record of the third and last database. Alternative embodiments may utilize other approaches.

In a first step 500 a set of criteria for consolidating records is accessed. The criteria are a set of rules for determining whether two records are describing the same individual. For example, if two records have the same social security number, then both records probably describe the same individual unless other data indicates otherwise such as birthdate and biometric data. The criteria can include a threshold amount or confidence amount acceptable for determining that two sets of biometric information are describing the same person. This threshold amount can vary depending on the type of biometric information used and the reliability of that biometric information. For example, fingerprint data may be considered more reliable than facial or voice recognition biometrics. Then in step 505 a record is accessed and loaded into memory from the first database for comparison with other records. For ease of reference, this record is considered the base record. In a third step 510, the next record in the databases is accessed for comparison with the first record. For ease of reference, this record is considered the comparison record. In many embodiments, as many records as practical may be preloaded into memory for the comparison to reduce any I/O latency.

In step 515, a comparison between the base record and the comparison record is performed in accordance with the accessed criteria. If there is a match based on non-biometric information based on the accessed criteria, then processing continues to step 520, otherwise processing continues to step 550. In step 520, the biometric information of each record is compared and a similarity score is generated. For example, identical biometric information would have a score of near 100 showing a near 100 percent confidence that the two sets of biometric information indicate the same person. However, a poor match may have a score of 20 showing essentially that there is an 80 percent confidence that the two sets of biometric information indicate different people. Many other types of similarity scores or other measure can be utilized. For example, a confidence in the underlying raw data may be utilized to help adjust the similarity score. If the underlying raw data is poor, then there is less confidence that similar biometric information indicates that both are derived from a single individual.

Then in step 525, the similarity score and the threshold amount are compared. If the similarity score is lower than the threshold amount, then the two records are deemed to not describe the same individual based on the criteria and processing continues to step 550. However, if the similarity score is higher than the threshold amount in step 525, then the two records are deemed as describing the same person based on the criteria and processing continues to step 530. In step 530, the records are consolidated into a single record or linked as such. Alternatively, a separate running record of consolidations may be generated as a separate database for subsequent processing. Processing then continues to step 550.

In step 550, it is determined whether the comparison record is the last record in the set of databases. If not, then in step 555 the next record is accessed, is considered as the comparison record, and processing returns to step 515. If the comparison record is determined to be the last record in the set of databases, then in step 560 it is determined whether the base record is the next to last record in the set of databases. If not, then in step 565 the next record in the set of databases is accessed and loaded into memory for comparison with other records. Subsequently in step 570 the following record in the set of databases (after the base record) is accessed for comparison with the base record and processing returns to step 515. If the base record was the next to last record in the set of databases, then comparison of the records has completed and in step 575 any final steps including steps necessary for documenting the results of the comparison are performed. This can include generating a report of the results for follow up. Processing then ceases.

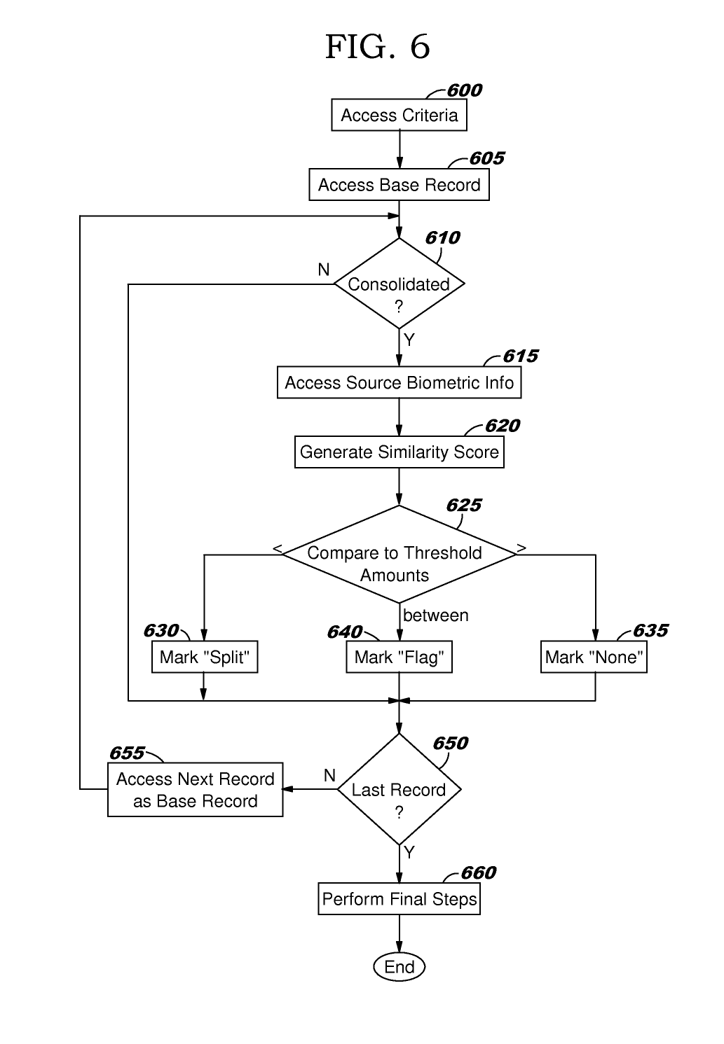

FIG. 6 is a flow diagram of a database deconsolidator reviewing a consolidated database for false nexuses in accordance with a second embodiment. In this embodiment, the only information compared for determining whether a false nexus has occurred is the biometric information. Additional non-biometric information could also be utilized to help determine whether a false nexus has occurred.

In a first step 600 a set of criteria for consolidating or deconsolidating records is accessed. The criteria are a set of rules for determining whether two records are describing the same individual and can be utilized for consolidating records or for determining that two records should not have been consolidated. For example, if two records have the same social security number, then both records probably describe the same individual unless other data indicates otherwise such as birthdate and biometric data. The criteria can include a threshold amount or confidence amount acceptable for determining that two sets of biometric information are describing the same person. This threshold amount can vary depending on the type of biometric information used and the reliability of that biometric information. For example, fingerprint data may be considered more reliable than facial or voice recognition biometrics. Also, two (or more) threshold amounts can be utilized (75 and 35 in this example). In this example, if a similarity score is higher than both threshold amounts, then the base record should not be deconsolidated (none). If the similarity score is less than both threshold amounts, then the base record is automatically deconsolidated (split). If the similarity score falls between the threshold amounts, then the base record should be flagged for additional screening (flag), perhaps by a human or by obtaining additional biometric information. In alternative embodiments, different sets of threshold amounts may be utilized with different separation action(s) taken in response to a comparison of a similarity score with the set threshold amounts.

Then in second step 605 a record is accessed and loaded into memory from the consolidated database for analysis. For ease of reference, this record is considered the base record. In a third step 610, is determined whether the base record is a consolidated record. This is determined by counting the number of source database records referenced by the base record. Each record of the consolidated database includes references to the source database records used to generate that consolidated database record. If there is only one source record referenced, then the record is not consolidated. If the record is not consolidated, then processing continues to step 650, otherwise processing continues to step 615.

In step 615, records corresponding to the referenced source database records are accessed from the biometric database. These records include biometric information that has not been considered before when consolidating the consolidated database. In the example provided, there may be one or more new biometric information for each source database record. However, there could none in some circumstances and more than two in other circumstances. Then in step 620, a similarity score is generated based on the available biometric information for this base record. For example, identical biometric information would have a score of near 100 showing a near 100 percent confidence that the two sets of biometric information indicate the same person. However, a poor match may have a score of 20 showing essentially that there is an 80 percent confidence that the two sets of biometric information indicate different people. Many other types of similarity scores or other measure can be utilized. For example, a confidence in the underlying raw data or the raw data itself may be utilized to help adjust the similarity score. If the underlying raw data is poor, then there is less confidence that similar biometric information indicates that both are derived from a single individual. The similarity score can be generated based on the new biometric information as well as any old biometric information which may be stored in the base record.

Although a single score is shown in this example, alternative embodiments may have more than three source database records consolidated to create the base record, each with its own set of biometric information. In such a set, a single similarity score may be generated or multiple similarity scores may be generated, one for each combinatorial pair of source records used to generate the base record. There may also be prior biometric information stored in the base record or elsewhere that was previously used to consolidate or deconsolidate the base record. That prior biometric information may also be utilized to generate the similarity score(s).

Then in step 625, the similarity score and the threshold amounts are compared. If the similarity score is lower than either threshold amount (75 and 35 in this example), then the two records are deemed to not describe the same individual based on the criteria and processing continues to step 630. However, if the similarity score is higher than both threshold amounts in step 620, then the two records are deemed as describing the same person based on the criteria and processing continues to step 635. Also, if the similarity score is between the threshold amounts, then further analysis is needed and processing continues to step 640.

In step 630, the similarity score and a separation action are appended to the base record. In this case, the separation action code is “Split” indicating that the base record should be deconsolidated due to a very low similarity score. This separation action can be performed later by another process or by the present process during the final step described below. Processing then continues to step 650. In step 635, the similarity score and a separation action are appended to the base record. In this case, the separation action code is “None” indicating that the base record should not be deconsolidated due to a very high similarity score. As a result, no further separation action is needed regarding the base record at this time. Processing then continues to step 650. In step 640, the similarity score and a separation action are appended to the base record. In this case, the separation action code is “Flag” indicating that further investigation is needed to determine whether a false nexus has occurred in the base record. This separation action can include human intervention and may be performed later by another process or by the present process during the final step described below. Processing then continues to step 650.

In steps 630, 635 and 640, a set of records may be generated in a deconsolidation results database instead of or in addition to appending the consolidated database. The deconsolidation results database can include a single record for every source database record found to be dissimilar (Split) or suspect (Flag) indicating a possible false nexus. Alternatively, a single record may be generated for each base record found to include dissimilar or suspect information indicating a possible false nexus. The deconsolidation results database can be processed later or by the present process during the final step described below. The deconsolidation results database does provide a useful audit trail of the deconsolidation results which may also be used for statistical analysis or other purposes.

In step 650, it is determined whether the base record is the last record in the consolidated database. If not, then in step 655 the next record in the consolidated database is accessed, is considered as the base record, and processing returns to step 610. Otherwise processing continues to step 660.

In step 660, the complete deconsolidation analysis of the consolidated database has been performed using the new biometric information contained in the biometric database. Final process steps can then be performed. This can include generating a report of the results for follow up with regards to the records flagged, initiating a process for deconsolidating the records with a separation action code indicating a record should be split, etc. Such a deconsolidation process can include segregating the records utilized to generate the consolidated record. Such a deconsolidation process can include accessing the original source database records to segregate the data according to source unless information regarding the source was retained with each type of data stored in the consolidated database. Processing then ceases.

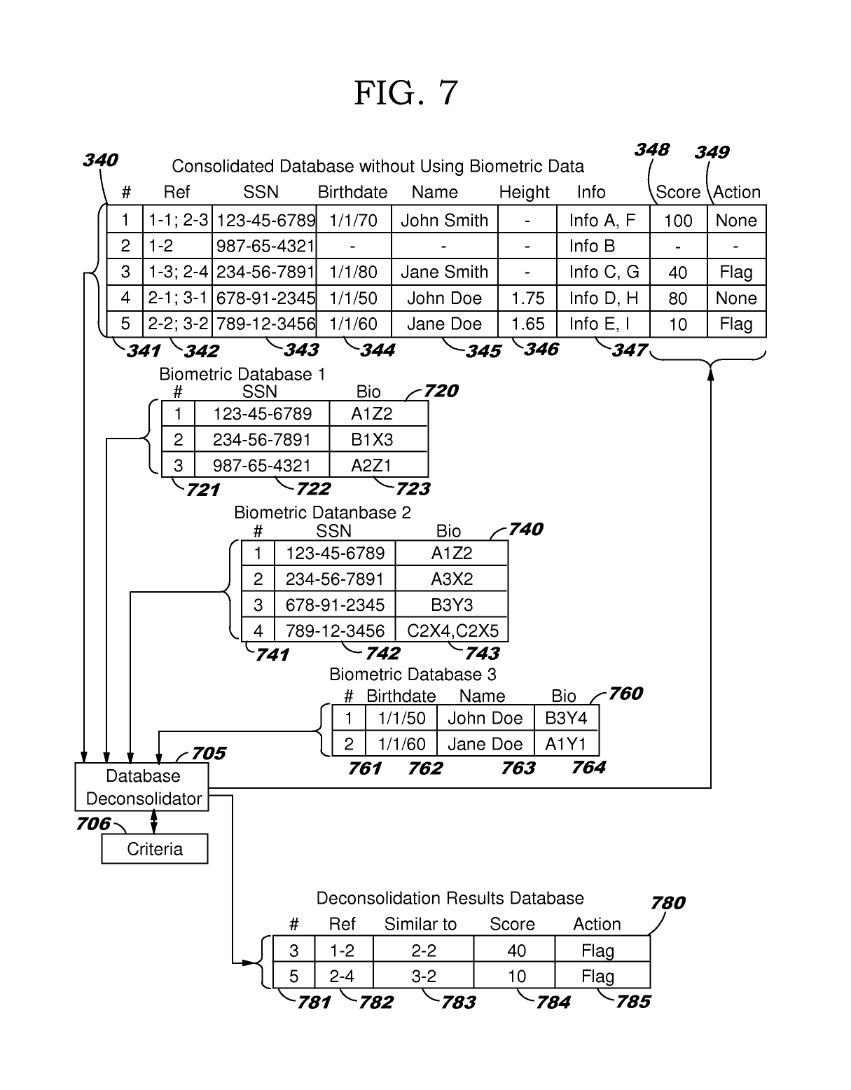

FIG. 7 is a block diagram of a system for deconsolidating a previously consolidated database in which a third embodiment may be implemented. In this embodiment, the biometric databases with biometric data may originate from the same sources as the original databases used to generate the consolidated database. However, the biometric databases have not been linked with or cross-referenced with the original databases. Instead, they may be considered as supplements to the original databases. As an example, a several banks with many common customers may have consolidated their databases prior to implementing the use of biometric data. Then once biometric information is gathered from each bank, such as from automatic teller machines (ATMs), that data may be collected with certain identifying information regarding the person being photographed and used for verifying the consolidation of data in the consolidated database.

Consolidated database 340 from FIG. 3 is shown as an example of a database consolidated without using consolidated data that can be deconsolidated by utilizing database deconsolidator 705 with a set of criteria 706 and biometric databases 720, 740 and 760. The consolidated database includes record number 341, reference identifier 342 of the source databases and records, social security number 343, birthdate 344, name 345, height 346 and other descriptive information 347. Also shown are a score 348 and separation action code 349 which are added to database 340 as described below. Alternatively, a deconsolidation results database 780 can be generated capturing the same information at score 348 and separation action code 349 as described below.

The criteria are a set of rules for determining whether two records are describing the same individual. For example, if two records have the same social security number, then both records probably describe the same individual unless other data indicates otherwise such as birthdate and biometric data. The criteria can include a threshold amount or confidence amount acceptable for determining that two sets of biometric information are describing the same person. This threshold amount can vary depending on the type of biometric information used and the reliability and credibility of that biometric information. For example, fingerprint data may be considered more reliable than facial or voice recognition biometrics. For another example, social security numbers may be considered more credible than birthdates due to its source and how it may be provided. That is, social security cards are often checked by employers whereas birth certificates are rarely checked. Criteria 706, consolidated database 340, biometric databases 720, 740 and 760 as well as deconsolidation results database 780 may be located in local memory or in remote servers or other data processing systems.

Also shown are biometric databases 720, 740 and 760 which can be utilized to identify any false nexus within consolidated database 340 based on criteria 706. Biometric database 720 includes a record number 721, a social security number 722 and biometric information 723. Biometric database 740 includes a record number 741, a social security number 742 and biometric information 743. Biometric database 760 includes a record number 761, a birthdate 762, a name 763 and biometric information 764. For comparison purposes, biometric information 723, 743 and 764 is the same biometric information that was stored in the source databases of FIG. 3. In this example, no raw data or confidence information is included, but such information could be utilized in alternative embodiments.

Database deconsolidator 705 uses the biometric information to determine whether there may have been any false consolidation of data between different individuals based on criteria 706. It accomplishes this by looking at each record in the consolidated database, looking up the biometric data corresponding to the non-biometric data such as social security number, generating a similarity score, and comparing that to a threshold to determine what separation action to take such as flagging the record to be further processed or split as a false nexus. A separation action includes the marking, separating and flagging actions as well as any other which would tend to selectively separate the consolidated data based on the detection of a false nexus. In this example, given the lack of linkages to the records of the original databases and the lack of raw data and confidence information, no records are automatically split. As a result, the only separation action is to flag the records for further investigation. This process is described in greater detail below. Database deconsolidator 705 may be implemented in software on a data processing system, in hardware as a specialized set of circuits, a combination of these approaches, or in other alternative implementations. Once a record is flagged as a false nexus, the record can be automatically deconsolidated or go through a secondary process possibly including human intervention to determine whether to deconsolidate the record. As illustrated in the example, two records (numbers 3 and 5) are flagged as having a low similarity score, thereby indicating a possible false nexus and a need to be split. Once deconsolidated, the resulting database could appear as shown in database 350 of FIG. 3.

Deconsolidation results database 780 is an alternative approach to identifying records which need a separation action performed such as being split or further processed. Results database includes a record number 781 of consolidated database 340, a reference number 782 to a record in the biometric database which may have caused the dissimilarity, a second reference number 783 to the record in the biometric database which also may have caused the dissimilarity, a similarity score 784 indicating the level of confidence in similarity (which is a low score for considering deconsolidation) and a separation action code 785. There is one record in the results database for each consolidated database record which may have a false nexus. Alternative embodiments may store additional information in each record or have one record for each biometric database record which is not similar to another corresponding (as identified through the consolidated database) biometric database record. By using deconsolidation results database 780, the consolidated database can be preserved in its original form until the results database can be processed at a later time. Deconsolidation results database 780 also creates an audit trail useful for a variety of purposes including statistical analysis.

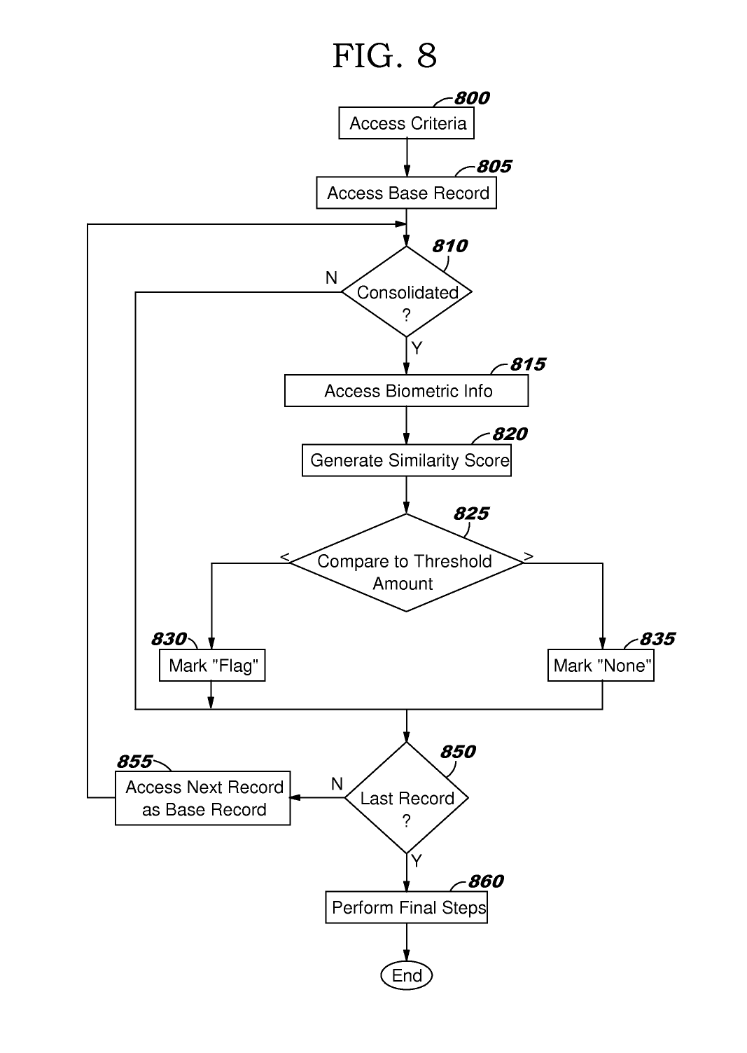

FIG. 8 is a flow diagram of a database deconsolidator reviewing a consolidated database for false nexuses in accordance with the third embodiment. In this embodiment, the only information compared for determining whether a false nexus has occurred is the biometric information. Additional non-biometric information could also be utilized to help determine whether a false nexus has occurred.

In a first step 800 a set of criteria for consolidating or deconsolidating records is accessed. The criteria are a set of rules for determining whether two records are describing the same individual and can be utilized for consolidating records or for determining that two records should not have been consolidated. For example, if two records have the same social security number, then both records probably describe the same individual unless other data indicates otherwise such as birthdate and biometric data. The criteria can include a threshold amount of similarity for determining that two sets of biometric information are describing the same person. This threshold amount can vary depending on the type of biometric information used and the reliability of that biometric information. A single threshold amount is utilized (75 in this example). In this example, if a similarity score is higher than the threshold amount, then the base record should not be flagged or deconsolidated (none). If the similarity score is less than the threshold amounts, then the consolidated database record is flagged for additional screening (flag), perhaps by a human or by obtaining additional biometric information. In alternative embodiments, different sets of threshold amounts may be utilized with different separation action(s) taken in response to a comparison of a similarity score with the set threshold amounts.

Then in second step 805 a record is accessed and loaded into memory from the consolidated database for analysis. For ease of reference, this record is considered the base record. In a third step 810, is determined whether the base record is a consolidated record. This is determined by counting the number of source database records referenced by the base record. Each record of the consolidated database includes references to the source database records used to generate that consolidated database record. If there is only one source record referenced, then the record is not consolidated. If the record is not consolidated, then processing continues to step 850, otherwise processing continues to step 815.

In step 815, the non-biometric information in each record of the various biometric databases is compared with the non-biometric information in the base record. If there is a match, then the biometric information for those matching records is retained for comparison. In the example provided, there may be one or more new biometric information for each base record. However, there could none in some circumstances and more than two in other circumstances. Then in step 820, a similarity score is generated based on the available biometric information for this base record. For example, identical biometric information would have a score of near 100 showing a near 100 percent confidence that the two sets of biometric information indicate the same person. However, a poor match may have a score of 20 showing essentially that there is an 80 percent confidence that the two sets of biometric information indicate different people. Many other types of similarity scores or other measure can be utilized. For example, a confidence in the underlying raw data or the raw data itself may be utilized to help adjust the similarity score. If the underlying raw data is poor, then there is less confidence that similar biometric information indicates that both are derived from a single individual. The similarity score can be generated based on the new biometric information as well as any old biometric information which may be stored in the base record. Although a single score is shown in this example, alternative embodiments may have more than three source database records consolidated to create the base record, each with its own set of biometric information. In such a set, a single similarity score may be generated or multiple similarity scores may be generated, one for each combinatorial pair of source records used to generate the base record. There may also be prior biometric information stored in the base record or elsewhere that was previously used to consolidate or deconsolidate the base record. That prior biometric information may also be utilized to generate the similarity score(s).

Then in step 825, the similarity score is compared with the threshold amount. If the similarity score is lower than the threshold amount (75 in this example), then the base record from the consolidated database may have a false nexus and processing continues to step 830. However, if the similarity score is higher than the threshold amount in step 820, then no false nexus is identified and processing continues to step 835.

In step 830, the similarity score and a separation action are appended to the base record. In this case, the separation action code is “flag” indicating that the base record should be deconsolidated due to a low similarity score. This separation action can be performed later by another process or by the present process during the final step described below. Processing then continues to step 850. In step 835, the similarity score and a separation action are appended to the base record. In this case, the separation action code is “None” indicating that the base record should not be deconsolidated due to a high similarity score. As a result, no further separation action is needed re the base record at this time. Processing then continues to step 850.

In steps 830 and 835, a set of records may be generated in a deconsolidation results database instead of or in addition to appending the consolidated database. The deconsolidation results database can include a single record for every consolidated database record found to be suspect (Flag) indicating a possible false nexus. The deconsolidation results database can be processed later or by the present process during the final step described below. The deconsolidation results database does provide a useful audit trail of the deconsolidation results which may also be used for statistical analysis or other purposes.

In step 850, it is determined whether the base record is the last record in the consolidated database. If not, then in step 855 the next record in the consolidated database is accessed, is considered as the base record, and processing returns to step 810. Otherwise processing continues to step 860.

In step 860, the complete deconsolidation analysis of the consolidated database has been performed using the new biometric information contained in the biometric database. Final process steps can then be performed. This can include generating a report of the results for follow up with regards to the records flagged. Processing then ceases.

In alternative embodiments, the processes described with reference to the first embodiment can be performed to generate a consolidated database with available biometric information, to be later updated with new biometric information as described in the second or third embodiments. In addition, many additional hybrid or alternative processes may be utilized to better utilize available biometric information as it becomes available.

The invention can take the form of an entirely software embodiment, or an embodiment containing both hardware and software elements. In a preferred embodiment, the embodiments are implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer usable medium(s) having computer usable program code embodied thereon.

Any combination of one or more computer usable medium(s) may be utilized. The computer usable medium may be a computer usable signal medium or a non-transitory computer usable storage medium. A computer usable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer usable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer usable storage medium may be any tangible medium that can contain, or store a program for use by or in connection with an instruction execution system, apparatus, or device.

A computer usable signal medium may include a propagated data signal with computer usable program code embodied therein, for example, in baseband or as part of a carrier wave. Such a propagated signal may take any of a variety of forms, including, but not limited to, electromagnetic, optical, or any suitable combination thereof. A computer usable signal medium may be a computer usable medium that is not a computer usable storage medium and that can communicate, propagate, or transport a program for use by or in connection with an instruction execution system, apparatus, or device.

Program code embodied on a computer usable medium may be transmitted using any appropriate medium, including but not limited to wireless, wireline, optical fiber cable, RF, etc., or any suitable combination of the foregoing. Further, a computer storage medium may contain or store a computer-usable program code such that when the computer-usable program code is executed on a computer, the execution of this computer-usable program code causes the computer to transmit another computer-usable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for using biometric data to identify data consolidation issues. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of identifying false nexuses in previously consolidated data comprising:
receiving a set of biometric information corresponding to a consolidated record of a consolidation database;
utilizing a processor to test the set of biometric data for similarity; and
responsive to detecting a similarity less than a threshold indicating a false nexus, performing a separation action related to the consolidated record.

2. The method of claim 1 wherein the consolidated record includes identification information from a set of records received from disparate data sources.

3. The method of claim 2 wherein the set of biometric information includes a first biometric data corresponding to a first record of the set of records and a second biometric data corresponds to a second record of the set of records; and wherein a similarity less than a threshold indicates the first record and the second record should not have been consolidated into the consolidated record in the consolidation database.

4. The method of claim 2 wherein the set of biometric information includes a first biometric data corresponding to a first disparate data source and a second biometric item corresponds to a second disparate data source; and wherein a similarity less than a threshold indicates the consolidated record should not have been consolidated in the consolidation database.

5. The method of claim 1 further comprising:
responsive to detecting a similarity greater than the threshold but less than a second threshold indicating a possible false nexus, performing a second separation action related to the consolidated record.

6. The method of claim 1 wherein the separation action is selected from a group consisting of marking, separating, and flagging.

7. The method of claim 1 wherein the biometric data is selected from a group consisting of facial recognition, fingerprints, voice recognition and DNA.

8. The method of claim 4 further comprising:
responsive to detecting a similarity greater than the threshold but less than a second threshold indicating a possible false nexus, performing a second separation action related to the consolidated record;
wherein the separation action is selected from a group consisting of marking, separating, and flagging; and
wherein the biometric data is selected from a group consisting of facial recognition, fingerprints, voice recognition and DNA.

9. A computer usable program product comprising a non-transitory computer usable storage medium including computer usable code for use in identifying false nexuses in previously consolidated data, the computer usable program product comprising code for performing the steps of:
receiving a plurality of biometric information corresponding to a consolidated record of a consolidation database;
utilizing a processor to test the set of biometric data for similarity; and
responsive to detecting a similarity less than a threshold indicating a false nexus, performing a separation action related to the consolidated record.

10. The computer usable program product of claim 9 wherein the consolidated record includes identification information from a set of records received from disparate data sources.

11. The computer usable program product of claim 10 wherein the set of biometric information includes a first biometric data corresponding to a first record of the set of records and a second biometric data corresponds to a second record of the set of records; and wherein a similarity less than a threshold indicates the first record and the second record should not have been consolidated into the consolidated record in the consolidation database.

12. The computer usable program product of claim 10 wherein the set of biometric information includes a first biometric data corresponding to a first disparate data source and a second biometric item corresponds to a second disparate data; and wherein a similarity less than a threshold indicates the consolidated record should not have been consolidated in the consolidation database.

13. The computer usable program product of claim 9 further comprising:
responsive to detecting a similarity greater than the threshold but less than a second threshold indicating a possible false nexus, performing a second separation action related to the consolidated record.

14. The computer usable program product of claim 9 wherein the separation action is selected from a group consisting of marking, separating, and flagging.

15. The computer usable program product of claim 9 wherein the biometric data is selected from a group consisting of facial recognition, fingerprints, voice recognition and DNA.

16. A data processing system for identifying false nexuses in previously consolidated data, the data processing system comprising:
a processor; and
a memory storing program instructions which when executed by the processor execute the steps of:
receiving a set of biometric information corresponding to a consolidated record of a consolidation database;
utilizing the processor to test the set of biometric data for similarity; and
responsive to detecting a similarity less than a threshold indicating a false nexus, performing a separation action related to the consolidated record.

17. The data processing system of claim 16 wherein the consolidated record includes identification information from a set of records received from disparate data sources.

18. The data processing system of claim 17 wherein the set of biometric information includes a first biometric data corresponding to a first record of the set of records and a second biometric data corresponds to a second record of the set of records; and wherein a similarity less than a threshold indicates the first record and the second record should not have been consolidated into the consolidated record in the consolidation database.

19. The data processing system of claim 17 wherein the set of biometric information includes a first biometric data corresponding to a first disparate data source and a second biometric item corresponds to a second disparate data; and wherein a similarity less than a threshold indicates the consolidated record should not have been consolidated in the consolidation database.

20. The data processing system of claim 16 further comprising:
responsive to detecting a similarity greater than the threshold but less than a second threshold indicating a possible false nexus, performing a second separation action related to the consolidated record.
